(19) United States
(12) Patent Application Publication
(10) Pub. No.: US 2007/0291309 A1
(43) Pub. Date: Dec. 20, 2007

(54) Layout planning apparatus, layout planning method, layout planning program, and recording medium storing layout planning program

(75) Inventor: Yoshihiro Kurimura, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/806,559

(22) Filed: Jun. 1, 2007

(30) Foreign Application Priority Data
Jun. 15, 2006 (JP) JP2006-166170

(51) Int. Cl. G06K 15/00

(52) U.S. Cl. 358/1.18

(57) ABSTRACT

When a composite signature includes two intermediate signatures imposed thereon, a first table generating section generates a first table showing the page composition of an intermediate signature imposed on the left side of each composite signature, on the basis of initial information entered by a user. A second table generating section generates a second table showing the page composition of an intermediate signature imposed on the right side of each composite signature. A third table generating section generates a third table showing the page composition of each composite signature on the basis of the first and second tables. A fourth table generating section generates a fourth table showing the page composition of each printing form on the basis of the third table. This facilitates layout planning for a printing/binding style of creating one signature with different contents imposed on two or more imposition areas.

### FIELD OF THE INVENTION

The present invention relates to a technique of carrying out layout planning for production of magazines, books or the like.

### DESCRIPTION OF THE BACKGROUND ART

Generally, in production of printed matter of book composition, such as magazines, books or the like, a layout plan is created which shows the page composition per printing form and page composition per signature in tabular form in order to grasp the overall construction of printed matter and the details of printing/binding based on the page compositions, and printing/binding is carried out on the basis of the layout plan. Such layout plan includes “a signature layout table” showing the page composition per signature and “a printing form layout table” showing the page composition per printing form.

Various styles may be employed in printing/binding based on know-how of each printer or bookmaker. Hereinafter, major printing/binding styles will be briefly described with reference to FIGS. 18A to 18B, 19A to 19C, 20A to 20D, and 21A and 21B, taking, as an example, production of printed matter containing 20 pages in total. In these drawings, each number surrounded by solid lines shall indicate the page number laid out on the side facing a viewer of the drawings, and each number surrounded by broken lines shall indicate the page number laid out on the opposite side of the viewer.

There is a printing/binding style of producing a single volume of printed matter in which a signature 301 with pages “1” to “8” imposed thereon, a signature 302 with pages “9” to “16” imposed thereon, and a signature 303 with pages “17” to “20” imposed thereon as shown in e.g., FIG. 18A are gathered as shown in FIG. 18B. Hereinafter, such style will be called a “single-signature-single-volume style”. In the present embodiment, the term “imposition” means laying out a plurality of pages of printed matter on printing paper according to a predetermined imposition pattern.

There is another printing/binding style of producing two volumes of printed matter 404 at a time in which a double signature 401 with two series of pages “1” to “8” respectively imposed on the left and right sides, a double signature 402 with two series of pages “9” to “16” respectively imposed on the left and right sides, and a double signature 403 with two series of pages “17” to “20” respectively imposed on the left and right sides as shown in e.g., FIG. 19A are gathered as shown in FIG. 19B, and then cut in two as shown in FIG. 19C. Hereinafter, such style will be called a “double-signature-two-volume style”.

There is still another printing/binding style of producing two volumes of printed matter 503 at a time by preparing a double signature 501 with a series of pages “1” to “8” and a series of pages “13” to “20” respectively imposed on the left and right sides and a double signature 502 with pages “9” to “10” and pages “11” to “12” respectively imposed on the left and right sides as shown in FIG. 20A, gathering two sets of the double signatures 501 and 502 as shown in FIG. 20B, overlaying the two sets on each other upon turning one of them inside out as shown in FIG. 20C, and cutting them in two as shown in FIG. 20D. Hereinafter, such style will be called a “double-signature-single-volume style”. The double-signature-single-volume style may involve a technique for producing a single volume of printed matter 503 as shown in FIG. 21B in which the signatures 501 and 502 gathered as shown in FIG. 20B are folded as shown in FIG. 21A.

In the double-signature-two-volume style or double-signature-single-volume style, a plurality of imposition areas are assigned on one printed sheet, and imposition is carried out in each area, which may hereinafter be called “pagination”. For instance, carrying out imposition in two imposition areas may be referred to as “double pagination”. A signature obtained by carrying out imposition in a plurality of imposition areas, namely, a signature obtained by pagination will be called “a composite signature”. Each of imposition areas in a composite signature, namely, each imposition unit included in a composite signature will be called “an intermediate signature”. For instance, the signature 501 shown in FIG. 20A is a composite signature obtained from a printed sheet with two imposition areas assigned on the left and right halves in the drawing, respectively. The signature 501 may be expressed as being made up of a first intermediate signature with pages “1” to “8” imposed thereon and a second intermediate signature with pages “13” to “20” imposed thereon.

In summary, the single-signature-single-volume style is a style of producing printed matter without creating any composite signature, and the double-signature-two-volume style is a style of producing two volumes of printed matter from composite signatures obtained by double pagination. The double-signature-single-volume style is a style of producing a single volume of printed matter from composite signatures obtained by double pagination. A style of producing a single volume of printed matter from composite signatures obtained by multi-pagination including the double-signature-single-volume style will hereinafter be called a multiple-signature-single-volume style.

A technique relating to this multiple-signature-single-volume style is publicly known which outputs printing paper with a plurality of pages different from one another in a single volume being laid out on one side of sheet in a printing system of stacking a continuously printed/output plurality of sheets of printing paper on one another and cutting them, to thereby print/bind printed matter (as disclosed in e.g., Japanese Patent Application Laid-Open No. 2001-205885).

The multiple-signature-single-volume style is a style in which one composite signature is made up of intermediate signatures with different pages imposed thereon, which avoids waste of printing paper and thus advantageously achieves excellent printing efficiency.

More specifically, with decreasing types of printed sheets to be created and increasing number of sheets of paper to be continuously printed for one printed sheet, the occurrence of spoilage throughout the printing process decreases, which in turn increases the printing efficiency. Comparing the double-signature-two-volume style and double-signature-single-volume style assuming that printed matter is produced with the same number of pages and the same number of copies, the double-signature-single-volume style requires less number of printing forms and less types of printed sheets, resulting in better printing efficiency with less spoilage.

As described, the employment of the multiple-signature-single-volume style including the double-signature-single-volume style achieves excellent effects particularly in terms of improved efficiency in printing process. With this multiple-signature-single-volume style, however, it is more difficult to carry out layout planning than with the single-signature-single-volume style and double-signature-two-volume style. This is the reason why the multiple-signature-single-volume style is not always generally employed.

For instance, in the case of producing printed matter with relatively less total number of print pages to be assigned and simple page composition (e.g., when all pages are monochrome pages), a layout plan may be created by actually folding paper in accordance with such page composition to check the position of pages. A plurality of layout plans created by such manner may previously be stored in a memory or the like, and any of the stored layout plans suitable for printed matter to be produced may be selected in printing/binding in the multiple-signature-single-volume style. Such method, however, can only provide layout plans for printed matter of simple composition, as a matter of course. When there is no suitable layout plan, it is not possible to carry out printing/binding in the multiple-signature-single-volume style.

The technique disclosed in the aforementioned JP2001-205885 is directed to production of printed matter by side wire stitching without requiring signatures to be created, and is therefore not applicable to binding upon creating signatures.

### SUMMARY OF THE INVENTION

The present invention is directed to a layout planning apparatus for carrying out layout planning for a printing/binding style of creating a plurality of signatures for use in production of printed matter, different contents being imposed on n imposition areas (where n is a power of 2) on each of the plurality of signatures. The layout planning apparatus comprises: an initial information obtaining section obtaining, as initial information, the total number of pages of the printed matter, a signature maximum page number representing a maximum number of pages that can be laid out on each of the n imposition areas and a sheet maximum page number representing a maximum number of pages that can be laid out on a sheet of printing paper; an area table generating section generating n area tables, the n area tables each showing a page composition of a predetermined imposition area included in the n imposition areas throughout the plurality of signatures, the predetermined imposition area arranged in a common position throughout the plurality of signatures, the area table generating section specifying the page composition on the basis of the initial information; a signature layout table generating section generating a signature layout table showing a page composition of each of the plurality of signatures on the basis of the n area tables; and a printing form layout table generating section generating a printing form layout table showing a page composition of each printing form on the basis of the signature layout table.

Layout planning can be carried out in accordance with and on the basis of initial information including the total number of pages of printed matter, the signature maximum page number that can be imposed on an imposition area and the sheet maximum page number that can be imposed on a sheet of printing paper. In other words, a user can readily carry out layout planning for a printing/binding style of creating one signature with different contents imposed on two or more imposition areas, by receiving these kinds of initial information.

Preferably, in the layout planning apparatus, the area table generating section includes: a main area table generating part generating a main area table showing a page composition of a predetermined imposition area included in the n imposition areas; and a sub-area table generating part generating (n−1) sub-area tables using the contents of the main area table, the (n−1) sub-area tables respectively showing page compositions of (n−1) imposition areas included in the n imposition areas except the predetermined imposition area.

Since the sub-area table is generated using the contents of the main area table, the efficiency in table generation is improved as compared to the case of independently generating area tables for the respective imposition areas. That is, layout planning can efficiently be carried out.

Preferably, in the layout planning apparatus, the signature layout table generating section generates the signature layout table by extracting the contents of page compositions of imposition areas to be included in a single signature from the n area tables.

Preferably, in the layout planning apparatus, the printing form layout table generating section includes a signature group forming part forming a signature group of signatures each having the same number of pages imposed. The printing form layout table generating section generates the printing form layout table by assigning only signatures that belong to the same signature group to a single printing form.

Since signatures belonging to the same signature group are assigned to a single printing form, an efficient printing form layout table can be generated.

Preferably, the layout planning apparatus further comprises an imposition pattern selecting part selecting an imposition pattern in the imposition areas to be included in the single signature.

Preferably, in the layout planning apparatus, the initial information obtaining section includes: a plate-type selection receiving part referring to a layout planning master and having a user select one of a plurality of plate types contained in the layout planning master, the layout planning master storing each of the plurality of plate types in association with the signature maximum page number and the sheet maximum page number; and a plate-type-associated information receiving part obtaining the signature maximum page number and the sheet maximum page number corresponding to the one of the plurality of plate types received by the plate-type selection receiving part, from the layout planning master.

The signature maximum page number and the sheet maximum page number are obtained from information on the plate type referring to the layout planning master, which simplifies a user's entering/setting operation of initial information.

Further, the present invention is also directed to a computer-readable recording medium having recorded therein a program for causing a computer to function as a layout planning apparatus for carrying out layout planning for a printing/binding style of creating a plurality of signatures for use in production of printed matter, different contents being imposed on n imposition areas (where n is a power of 2) on each of the plurality of signatures

Furthermore, the present invention is also directed to a layout planning method of carrying out layout planning for a printing/binding style of creating a plurality of signatures for use in production of printed matter, different contents being imposed on n imposition areas (where n is a power of 2) on each of the plurality of signatures.

It is therefore an object of the present invention to provide a technique for layout planning for a printing/binding style of creating one signature with different contents imposed on two or more imposition areas.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing the configuration of a layout planning apparatus according to a preferred embodiment of the present invention;

FIG. 2 is a schematic diagram showing the functional structure of the layout planning apparatus;

FIG. 3 is a flow chart showing the steps of carrying out layout planning;

FIG. 4 is a flow chart showing the steps of generating a first table;

FIG. 5 is a flow chart showing the steps of generating a second table;

FIG. 6 is a flow chart showing the steps of generating a third table;

FIG. 7 is a flow chart showing the steps of generating a fourth table;

FIGS. 8A and 8B are flow charts showing the steps of generating a signature layout table and a printing form layout table, respectively;

FIG. 9 is a diagram showing an exemplary construction of a layout planning master;

FIG. 10 is a explanatory diagram of relationship between table construction and composite signatures;

FIGS. 11A and 11B are diagrams showing an exemplary construction of the first and second tables, respectively;

FIG. 12 is a diagram showing an exemplary construction of the third table;

FIG. 13 is a diagram showing an exemplary construction of the fourth table;

FIG. 14 is a diagram showing an exemplary construction of a signature layout table;

FIG. 15 is a diagram showing an exemplary construction of a printing form layout table;

FIG. 16 is a diagram showing an exemplary construction of a signature layout table;

FIG. 17 is a diagram showing an exemplary construction of a printing form layout table; and

FIGS. 18A, 18B, 19A to 19C, 20A to 20D, and 21A and 21B are diagrams showing an exemplary construction of signatures when producing printed matter of 20 pages in total.

### DESCRIPTION OF THE PREFERRED EMBODIMENTS

### Apparatus Configuration

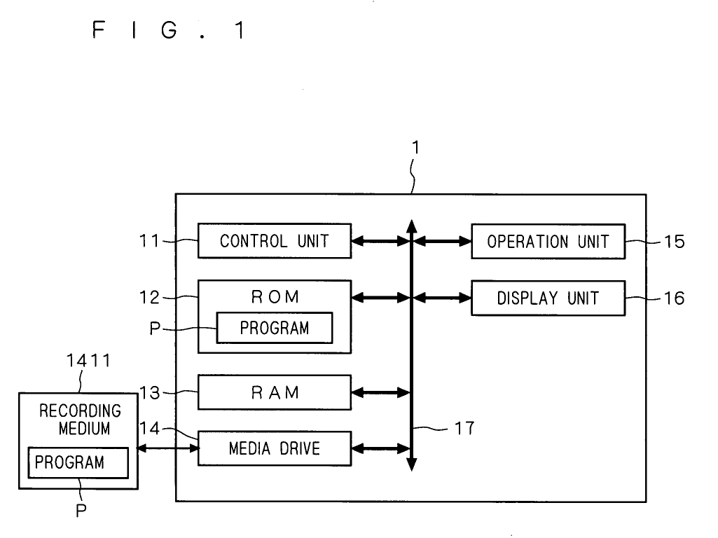

FIG. 1 is a schematic diagram showing the configuration of a layout planning apparatus 1 according to a preferred embodiment of the present invention. The layout planning apparatus 1 is intended to carry out layout planning for production of magazines, books or the like, and particularly to carry out layout planning for a printing/binding style of creating one signature with different contents imposed on two or more imposition areas.

This layout planning apparatus 1 is employed, for example, in a printing/binding system for carrying out printing/binding on the basis of digital data. In addition to this layout planning apparatus 1, the printing/binding system is provided with, as a preferable example, equipment for creating contents data per page, equipment for creating data per sheet of printing paper from page data on the basis of layout tables, equipment for printing/outputting printing data, and binding equipment including a paper cutter, a folding machine, a gathering machine, a binding machine, etc.

The layout planning apparatus 1 includes a control unit 11, ROM 12, RAM 13, media drive 14, operation unit 15 and display unit 16, all electrically connected to one another via a bus line 17.

The control unit 11 is made up of CPU, and controls the above-described pieces of hardware on the basis of a program P read by the media drive 14 or program P stored in the ROM 12, to thereby implement the functions of the layout planning apparatus 1.

The ROM 12 is a read-only memory having the program P and data necessary for controlling the layout planning apparatus 1 previously stored therein.

The RAM 13 is a memory that can be written to and read from, and temporarily stores data generated in operations by the control unit 11 and the like. The RAM 13 is made up of SRAM, flash memory, or the like.

The media drive 14 is a functional part for reading information stored in a recording medium 1411 (more specifically, portable recording medium such as CD-ROM, DVD (digital versatile disk), flexible disk, etc.).

The operation unit 15 is an input device made up of a keyboard and a mouse, and receives a user's operation such as entering a command or various types of data. The user's operation received by the operation unit 15 is input to the control unit 11 as a signal.

The display unit 16 includes a monitor and the like to display generated layout tables, operating conditions of the layout planning apparatus 1, and the like.

### 2. Functional Structure

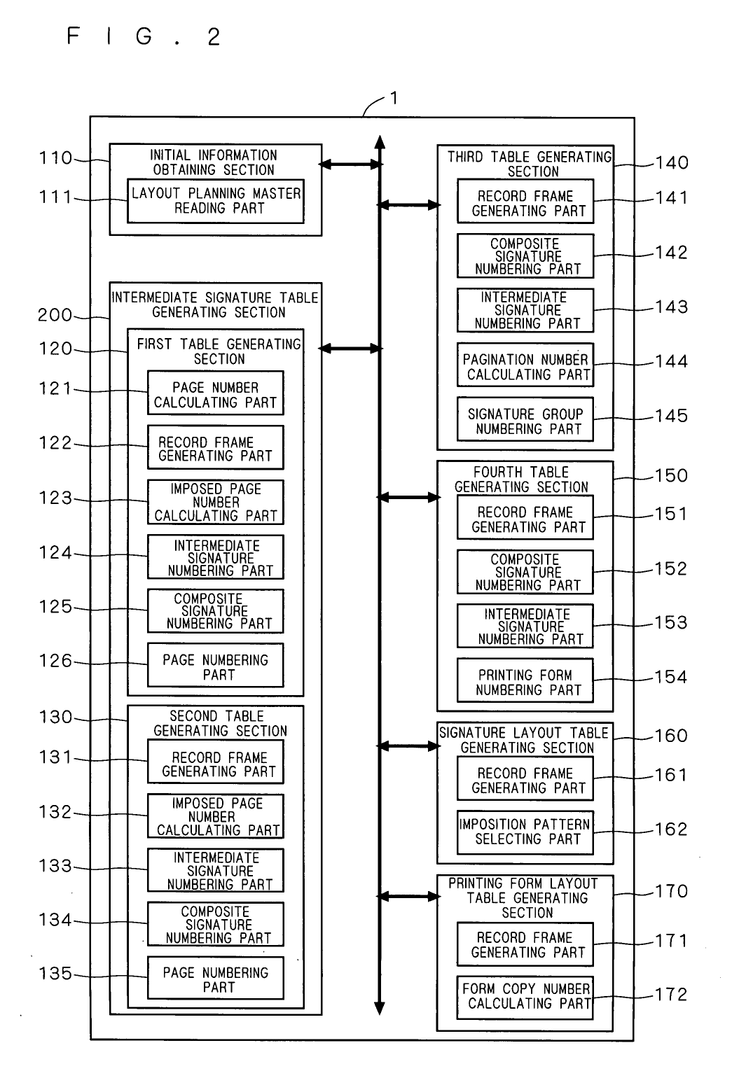

FIG. 2 is a schematic diagram showing the functional structure of the layout planning apparatus 1. In the layout planning apparatus 1, the program P previously stored in the ROM 12 or the like, or the program P stored in the recording medium 1411 is read out and executed in the control unit 11, so that the function of each part shown in FIG. 2 is implemented.

### 2-1. Initial Information Obtaining Section

An initial information obtaining section 110 is a processing part for obtaining initial information necessary for generating layout tables, and more specifically, obtains information such as “total page number”, “signature maximum page number”, “sheet maximum page number” and the like as initial information for layout planning on the basis of a user's input operation through the operation unit 15. The initial information obtaining section 110 may obtain necessary information from an external device connected via a communication line, rather than obtaining information on the basis of user's direct input.

The “total page number” represents the total number of pages of printed matter that a user wants to produce. The present embodiment assumes that a volume of printed matter to be produced shall be made up of a single type of component (e.g., “monochrome body”) only, not a plurality of types of components such as “color body” and “monochrome body”.

The “signature maximum page number” represents the maximum number of pages that can be imposed on a single intermediate signature, i.e., the maximum number of pages that can be imposed on a single imposition area. This value is determined by the performance of a folding machine to be used in a binding stage, the quality of printing paper to be used in printing, and the like. The product of the “signature maximum page number” and the number of intermediate signatures imposed on each composite signature is the maximum number of pages that can be laid out on a single composite signature.

The “sheet maximum page number” represents the maximum number of pages that can be laid out on a single sheet of printing paper. This value is determined by the performance of a printing press to be used in a printing stage, page size, and the like.

Preferably, in the layout planning apparatus 1, a layout planning master is previously stored in the RAM 13 or the like, and the initial information obtaining section 110 includes a layout planning master reading part 111. The “layout planning master” is a table storing the “signature maximum page number” and the “sheet maximum page number” in association with “plate types” obtained by classifying basic sizes in binding/printing according to final sizes. The layout planning master reading part 111 refers to the contents of the layout planning master, and presents all the “plate types” stored in the layout planning master on the display unit 16 in such a manner that a user can select one of them. When a user selects a “plate type” to be applied to printed matter that he/she wants to produce together with setting the “total page number” through the operation unit 15, the layout planning master reading part 111 obtains, in response to this selection, values of the signature maximum page number and the sheet maximum page number corresponding to the selected plate type from the layout planning master.

### 2-2. Intermediate Signature Table Generating Section

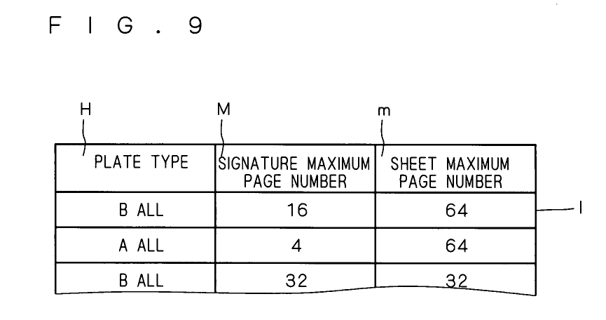

An intermediate signature table generating section 200 is a processing part for generating a table showing the page composition per intermediate signature. The present embodiment will describe layout planning for the double-signature-single-volume style of generating a composite signature with double intermediate signatures paginated as shown in FIG. 10. In such case, the intermediate signature table generating section 200 generates two tables, i.e., a table (hereinafter referred to as a “first table T1”) showing the page composition of an intermediate signature imposed on the left side of the composite signature and a table (hereinafter referred to as a “second table T2”) showing the page composition of an intermediate signature imposed on the right side of the composite signature. A first table generating section 120 generates the first table T1, and a second table generating section 130 generates the second table T2.

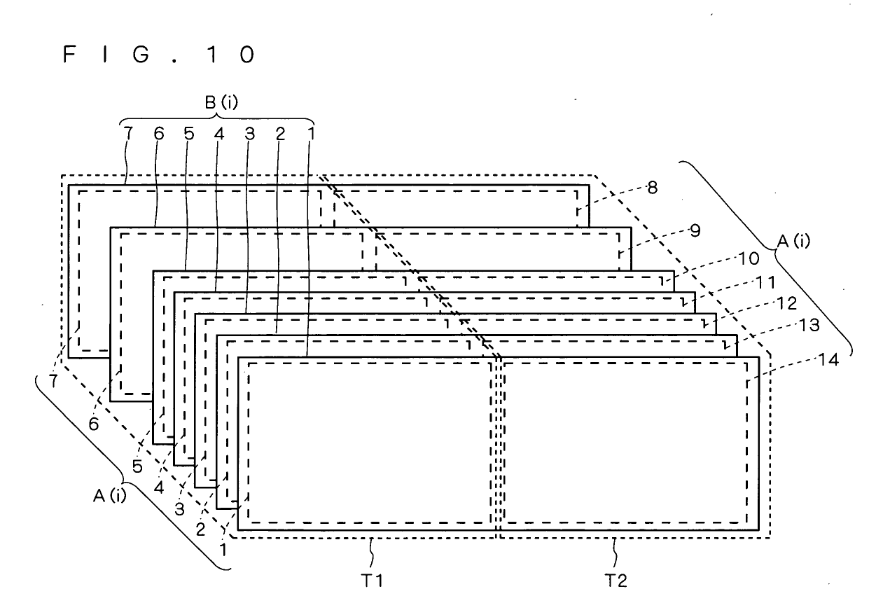

FIGS. 11A and 11B are diagrams showing an exemplary construction of first and second tables T1 and T2, respectively. The first and second tables T1 and T2 each contain records as many as a required number of intermediate signatures. In the first and second tables T1 and T2, the i-th record (i=1, 2, . . . ) will be simply called a record i, and each record i (i=1, 2, . . . ) contains the respective items of: the number of imposed pages S(i); intermediate signature number A(i); composite signature number B(i); start page number PS(i); and end page number PE(i).

The number of imposed pages S(i) represents the total number of pages to be imposed on an intermediate signature corresponding to the record i.

The intermediate signature number A(i) represents the number that identifies an intermediate signature corresponding to the record i. The composite signature number B(i) represents the number that identifies a composite signature corresponding to the record i.

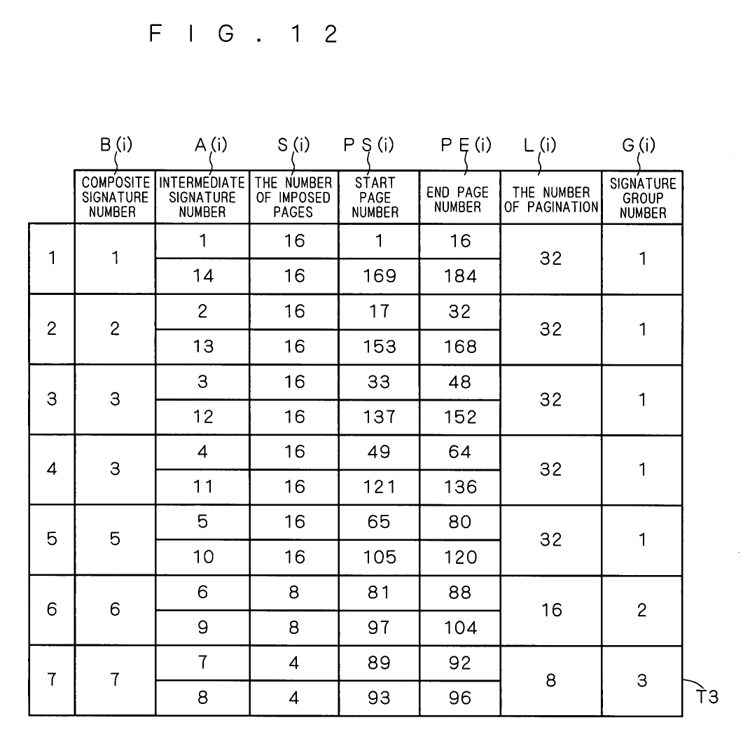

The start page number PS(i) represents the page number of start page among pages imposed on an intermediate signature corresponding to the record i. The end page number PE(i) represents the page number of end page among pages imposed on an intermediate signature corresponding to the record i. That is, the start page number PS(i) and end page number PE(i) define the range of page numbers (page number P(i); cf. FIG. 14) to be imposed on an intermediate signature.

### First Table Generating Section

The first table generating section 120 includes a page number calculating part 121, a record frame generating part 122, an imposed page number calculating part 123, an intermediate signature numbering part 124, a composite signature numbering part 125 and a page numbering part 126. The first table generating section 120 sequentially generates a required number of records (as many as intermediate signatures to be generated), starting from the 1st record corresponding to the 1st intermediate signature, to thereby complete the first table T1.

The page number calculating part 121 calculates the number of pages to be assigned in the first table T1, i.e., the number of pages constituting all intermediate signatures whose page compositions are to be described in the first table T1, on the basis of the “total page number” obtained as initial information. In the present embodiment, this value is obtained by dividing the obtained “total page number” by 2 since two intermediate signatures are respectively paginated on the left and right sides of each composite signature.

The record frame generating part 122 sequentially judges whether or not to generate the i-th record i on the basis of a predetermined conditional expression, starting from the 1st record corresponding to the 1st intermediate signature. When the i-th record i is judged to be generated, the record frame generating part 122 allocates an area for describing the record i in the first table T1. The judgment as to generation of the record i is made on the basis of large or small of the difference between the number of pages remaining as a target of assignment and the number of pages required to constitute an intermediate signature corresponding to the record i. The number of pages remaining as a target of assignment is a value obtained after the number of pages to be assigned to each record starting from the 1st record is sequentially subtracted taking, as an initial value, the total number of pages to be assigned having been calculated by the page number calculating part 121, and pages are assigned to an intermediate signature corresponding to the (i−1)th record. This will be described later in detail. The area for describing the record i in the first table T1 will be called a “record frame” for the record i. In other words, the record frame generating part 122 is a processing part for generating the record frame for the record i when predetermined conditions are met. Values obtained by the following functional parts are described in each record frame generated by the record frame generating part 122, so that a record corresponding to each record frame is generated. Hereinbelow, the area for describing the record i will also be called a “record frame” for the record i in other tables T2, T3, T4, T5 and T6 generated in the present embodiment.

The imposed page number calculating part 123 is a processing part for obtaining the number of imposed pages S(i). In the present embodiment, when the “signature maximum page number” obtained as initial information takes its maximum value and the page number to be imposed is smaller than the maximum value, the number of imposed pages S(i) is set at its maximum value up to (½)^{t} times (t=1, 2, . . . ) the “signature maximum page number” so as not to exceed the page number to be imposed.

The intermediate signature numbering part 124 is a processing part for giving the intermediate signature number A(i), and more specifically, gives values in ascending order in correspondence to the order of generation of record frames taking 1 as an initial value.

The composite signature numbering part 125 is a processing part for giving the composite signature number B(i), and more specifically, gives values in ascending order in correspondence to the order of generation of record frames taking 1 as an initial value.

The page numbering part 126 is a processing part for obtaining the start page number PS(i) and end page number PE(i), and more specifically, obtains the start page number PS(i) by sequentially adding an imposed page number S(i−1) in correspondence to the order of generation of record frames taking 1 as an initial value, and generates the end page number PE(i) by sequentially adding the number of imposed pages S(i) in correspondence to the order of generation of record frames taking S(1) as an initial value.

### Second Table Generating Section

The second table generating section 130 includes a record frame generating part 131, an imposed page number calculating part 132, an intermediate signature numbering part 133, a composite signature numbering part 134 and a page numbering part 135. The second table generating section 130 sequentially generates records as many as the records generated in the first table T1, to thereby complete the second table T2.

The record frame generating part 131 is a processing part for generating record frames constituting the second table T2, and more specifically, generates record frames as many as the record frames generated in the first table T1.

The imposed page number calculating part 132 is a processing part for calculating the number of imposed pages S(i), and more specifically, obtains the value of the number of imposed pages S(i) for the record i in the first table T1 to output it as a value of the number of imposed pages S(i) for the record frame i in the second table T2.

The intermediate signature numbering part 133 is a processing part for giving the intermediate signature number A(i), and more specifically, gives values in ascending order in correspondence to the reverse order of generation of record frames taking, as an initial value, a value larger by 1 than the largest one of intermediate signature numbers given in the first table T1.

The composite signature numbering part 134 is a processing part for giving the composite signature number B(i), and more specifically, gives values in ascending order of generation of record frames taking 1 as an initial value.

The page numbering part 135 is a processing part for obtaining the start page number PS(i) and end page number PE(i), and more specifically, obtains the start page number PS(i) by sequentially adding an imposed page number S(i+1) in correspondence to the reverse order of generation of record frames, taking, as an initial value, a value obtained by adding 1 to the end page number PE(M1) of the last record M1 in the first table T1 (i.e., a value of start page number PS(M2) of the last record M2 in the second table T2). The page numbering part 135 obtains the end page number PE(i) by sequentially adding the number of imposed pages S(i) in correspondence to the reverse order of generation of record frames, taking, as an initial value, a value obtained by adding the imposed page number S(M2) to the end page number PE(M1) (i.e., a value of end page number PE(M2)).

### 2-3. Third Table Generating Section

A third table generating section 140 is a processing part for generating a table (hereinafter referred to as a “third table T3”) showing the page composition of each composite signature.

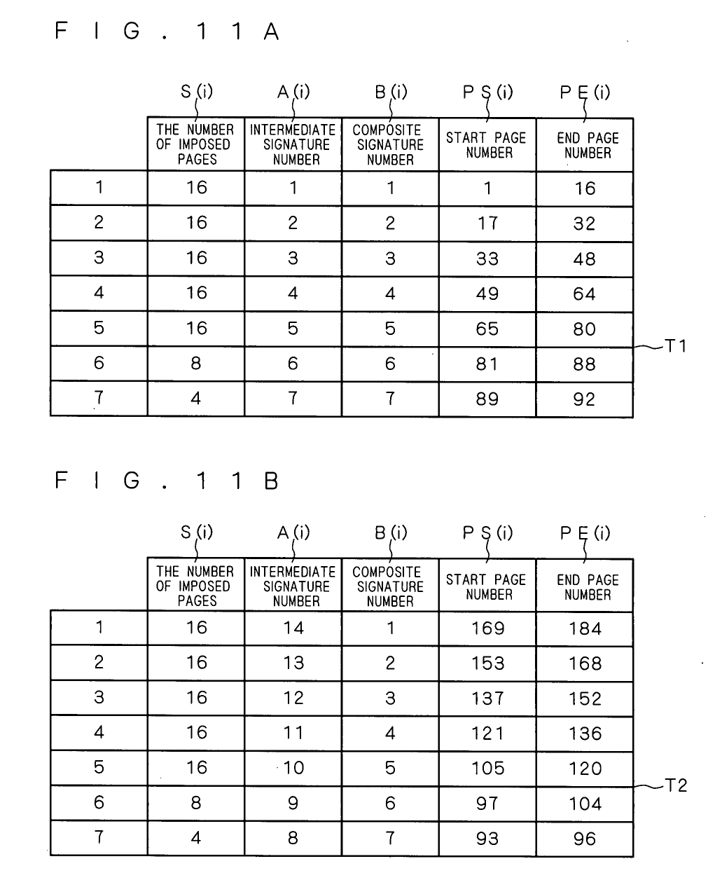

FIG. 12 is a diagram showing an exemplary construction of the third table T3. The third table T3 contains records as many as a required number of composite signatures. In the third table T3, the i-th record (i=1, 2, . . . ) will be simply called a record i. In the third table T3, each record i (i=1, 2, . . . ) contains the respective items of: composite signature number B(i); intermediate signature number A(i); number of imposed pages S(i), start page number PS(i); end page number PE(i); number of pagination L(i); and group number G(i).

The number of pagination L(i) represents the total number of pages to be imposed on a composite signature corresponding to the record i.

The group number G(i) represents the number that identifies a group attribute of the record i. Other items are the same as those in the first and second tables T1 and T2.

The third table generating section 140 includes a record frame generating part 141, a composite signature numbering part 142, an intermediate signature numbering part 143, a pagination number calculating part 144 and a signature group numbering part 145. The third table generating section 140 generates a required number of records (as many as composite signatures to be generated) sequentially from the 1st record corresponding to the 1st composite signature, to thereby complete the third table T3.

The record frame generating part 141 is a processing part for generating record frames constituting the third table T3, and more specifically, generates record frames as many as the record frames generated in the first table T1.

The composite signature numbering part 142 is a processing part for giving the composite signature number B(i), and more specifically, obtains the value of the composite signature number B(i) for the record i in the first table T1 (or the second table T2) to output it as the composite signature number B(i) for the record frame i in the third table T3.

The intermediate signature numbering part 143 is a processing part for giving the intermediate signature number A(i), and more specifically, obtains the value of the intermediate signature number A(i) for the record i in the first table T1 and the value of the intermediate signature number A(i) for the record i in the second table T2, to thereby output these two values as the intermediate signature number A(i) for the record frame i in the third table T3. In other words, the intermediate signature numbers A(i) having the same composite signature number B(i) in the first and second tables T1 and T2 are output as the intermediate signature numbers A(i) for the same record in the third table T3.

The pagination number calculating part 144 is a processing part for calculating the number of pagination L(i), and more specifically, calculates the sum of imposed page numbers S(i) stored in the respective record frames i in the third table T3.

The signature group numbering part 145 is a processing part for giving the signature group number G(i), and more specifically, forms signature groups each composed of records i having the same number of pagination L(i), and gives numbers from 1 that identify the respective signature groups from one another in ascending order of generation of the signature groups.

### 2-4. Fourth Table Generating Section

A fourth table generating section 150 is a processing part for generating a table (hereinafter referred to as a “fourth table T4”) showing the page composition of each printing form.

FIG. 13 is a diagram showing an exemplary construction of the fourth table T4. The fourth table T4 contains records as many as a required number of printing forms. In the fourth table T4, the i-th record (i=1, 2, . . . ) will be simply called a record i. In the fourth table T4, each record i (i=1, 2, . . . ) contains the respective items of: signature group number G(i); composite signature number B(i); intermediate signature number A(i); number of layout E(i); and printing form number Y(i).

The number of layout E(i) represents the number of composite signatures to be laid out on a printing form corresponding to the record i.

The printing form number Y(i) represents the number that identifies a printing form corresponding to the record i. Other items are the same as those in the first to third tables T1 to T3.

The fourth table generating section 150 includes a record frame generating part 151, a composite signature numbering part 152, an intermediate signature numbering part 153 and a printing form numbering part 154. The fourth table generating section 150 generates a required number of records (as many as printing forms to be generated) sequentially from the 1st record corresponding to the 1st printing form, to thereby complete the fourth table T4.

The record frame generating part 151 sequentially judges whether or not to generate the i-th record i on the basis of a predetermined conditional expression, starting from the 1st record corresponding to the 1st printing form. When the i-th record i is judged to be generated, the record frame generating part 151 allocates an area for describing the record i in the fourth table T4. The judgment as to generation of the record i is made on the basis of large or small of the difference between the number of composite signatures remaining as a target of assignment and the number of composite signatures required to constitute a printing form corresponding to the record i. The number of composite signatures remaining as a target of assignment is a value obtained after the number of composite signatures to be assigned to each record starting from the 1st record is sequentially subtracted taking, as an initial value, the total number of composite signatures to be assigned, and composite signatures are assigned to a printing form corresponding to the (i−1)th record. This will be described later in detail. Values obtained by the following functional parts are described in each record frame generated by the record frame generating part 151, so that the record corresponding to each record frame is generated.

The composite signature numbering part 152 is a processing part for giving the composite signature number B(i), and more specifically, reads out records in the third table T3 as many as composite signatures to be assigned to record frame in the fourth table T4 and outputs the composite signature number B(i) of the record frame i having been read out, as composite signature number B(i) in the fourth table T4.

The intermediate signature numbering part 153 is a processing part for giving the intermediate signature number A(i), and more specifically, outputs the intermediate signature number A(i) of the record i in the third table T3 having been read out by the composite signature numbering part 152, as the intermediate signature number A(i) in the fourth table T4.

The printing form numbering part 154 is a processing part for giving the printing form number Y(i), and more specifically, gives values in ascending order in correspondence to the order of generation of record frames.

### 2-5. Signature Layout Table Generating Section

A signature layout table generating section 160 generates a table (hereinafter called a “signature layout table T5”) indicating the page composition and imposition pattern for each composite signature.

FIG. 14 is a diagram showing an exemplary construction of the signature layout table T5. The signature layout table T5 contains records as many as a required number of composite signatures. In the signature layout table T5, the i-th record (i=1, 2, . . . ) will be simply called a record i. In the signature layout table T5, each record i (i=1, 2, . . . ) contains the respective items of: composite signature number B(i); intermediate signature number A(i); number of imposed pages S(i); start page number PS(i); end page number PE(i); number of pagination L(i); and imposition pattern SQ.

The imposition pattern SQ represents information on an imposition pattern of pages to be imposed on an intermediate signature paginated on a composite signature corresponding to the record i. Other items are the same as those in the third table T3.

The signature layout table generating section 160 includes a record frame generating part 161 and an imposition pattern selecting part 162.

The record frame generating part 161 is a processing part for generating record frames constituting the signature layout table T5, and more specifically, generates record frames as many as those generated in the third table T3.

The imposition pattern selecting part 162 is a processing part for selecting the imposition pattern, and more specifically, performs predetermined processing for prompting a user to select either one of a plurality of types of imposition patterns previously stored in the RAM 13 or the like, and stores an imposition pattern selected by the user in the item of imposition pattern SQ.

### 2-6. Printing Form Layout Table Generating Section

A printing form layout table generating section 170 generates a table (hereinafter called a “printing form layout table T6”) indicating the page composition and form copy number of each printing form.

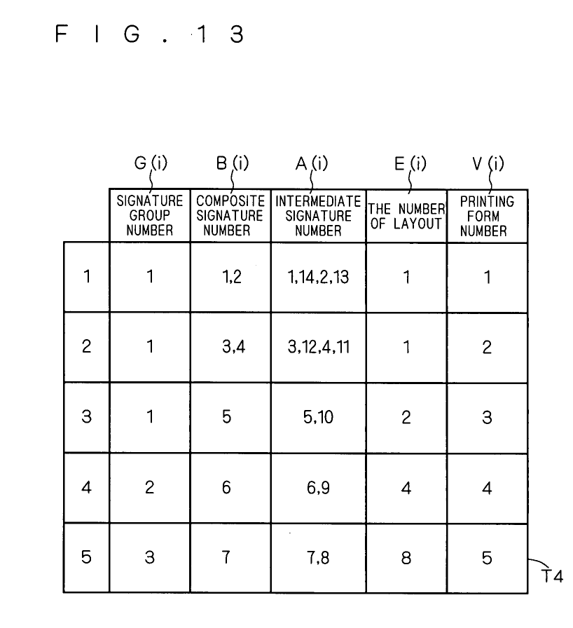

FIG. 15 is a diagram showing an exemplary construction of the printing form layout table T6. The printing form layout table T6 contains records as many as a required number of printing forms. In the printing form layout table T6, the i-th record (i=1, 2, . . . ) will be simply called a record i. In the printing form layout table T6, each record i (i=1, 2, . . . ) contains the respective items of: printing form number Y(i); composite signature number B(i); intermediate signature number A(i); number of layout E(i); plate type H; and form copy number V(i).

The form copy number V(i) represents the number of copies of the printing form corresponding to the record i. Other items are the same as those in the third table T3.

The printing form layout table generating section 170 includes a record frame generating part 171 and a form copy number calculating part 172.

The record frame generating part 171 is a processing part for generating record frames constituting the printing form layout table T6, and more specifically, generates record frames as many as those generated in the fourth table T4.

The form copy number calculating part 172 is a processing part for calculating the form copy number V(i), and more specifically, upon receipt of a user's entered value of the total number of printed matter (total volumes J) to be produced, divides the total volumes J by the number of layout E(i), to thereby obtain the form copy number V(i).

### 3. Layout Planning

FIG. 3 is a flow chart showing the steps of carrying out layout planning for the double-signature-single-volume style with the layout planning apparatus 1.

### 3-1. Initial Information Obtaining Process

The initial information obtaining section 110 receives initial information necessary for layout planning from a user (steps S21 to S22).

First, the total page number P which is a piece of initial information entered by a user is obtained (step S21). More specifically, the initial information obtaining section 110 carries out predetermined processing for prompting a user to enter the total page number P (e.g., by displaying a message reading “Enter the total number of pages of printed matter” on the display part 16). When the user enters a value in response to the message, the entered value is received as the total page number P.

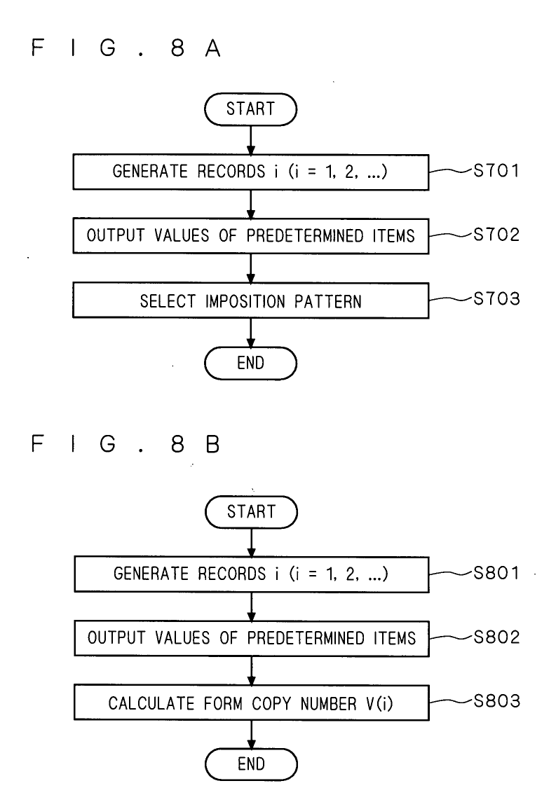

Next, the signature maximum page number M and sheet maximum page number m which are also initial information are read (step S22). More specifically, the layout planning master reading part 111 refers to the layout planning master I (cf. FIG. 9) to read out a list of candidates for plate type H stored in the layout planning master. Then, the initial information obtaining section 110 displays the list of candidates for plate type H on the display unit 16, and carries out predetermined processing for prompting a user to select either one of the candidates for plate type H having been read out (e.g., by displaying a message reading “Select a plate type” on the display unit 16). When the user selects a plate type H in response to the message, then, the layout planning master reading part 111 reads the signature maximum page number M and sheet maximum page number m from the layout planning master I in correspondence to the selected plate type H.

Hereinafter, as a specific example, the progress of processing when a user enters a total page number P of 184 and selects “B all” as the plate type H on the basis of the layout planning master I illustrated in FIG. 9 will also be described. In such case, a signature maximum page number M of 16 and a sheet maximum page number m of 64 shall be obtained.

### 3-2. Intermediate Signature Table Generating Process

### First Table

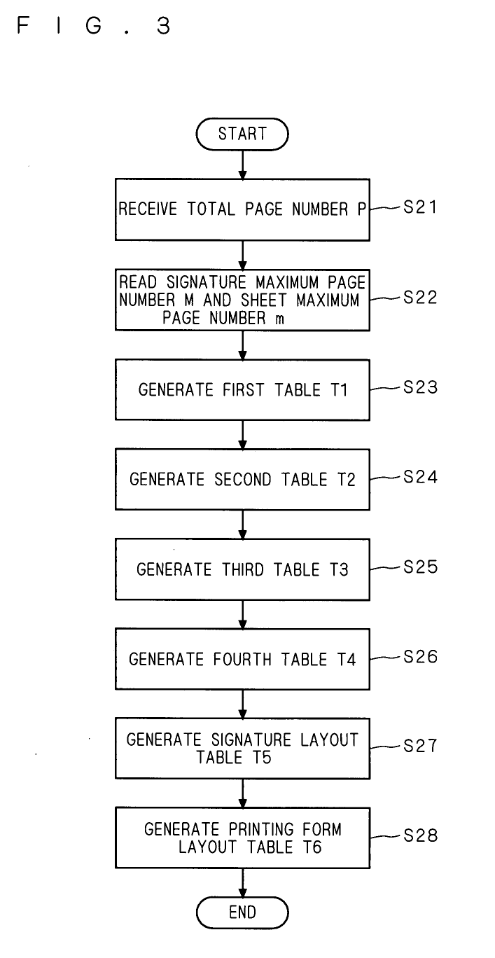

Next, the first table generating section 120 generates the first table T1 on the basis of the initial information obtained in steps S21 and S22 (step S23). FIG. 4 is a flow chart showing the steps of generating the first table T1.

First, the page number calculating part 121 calculates the number of pages Q(0) to be assigned in the first table T1 of the total page number P by dividing the total page number P by 2. When P=184, Q(0)=92 holds.

Next, the record frame generating part 122 generates record frames for the records constituting the first table T1 one by one, and the imposed page number calculating part 123 calculates the number of imposed pages S(i) for a generated record frame i. This will be described below more specifically.

First, the value i is set at 1 (step S302).

Then, the value t is set at 0 (step S303). The value t will define the number of imposed pages S(i) as will be described later.

Next, a temporarily remaining number of pages R(i) is obtained by executing an operation of: Q(i−1)−{(signature maximum page number M)/2^{t}} (step S304). In this expression, the term Q(i−1) represents the number of pages remaining after assigning pages on an intermediate signature corresponding to the (i−1)th record. The term {(signature maximum page number M)/2^{t}} represents a value set as a candidate for the number of imposed pages S(i) for the intermediate signature corresponding to the i-th record. In other words, the temporarily remaining number of pages R(i) is obtained by temporarily subtracting {(signature maximum page number M)/2^{t}} from the number of pages yet to be assigned. Since Q(0)=92, signature maximum page number M=16 and t=0, the temporary remaining page number R(1)=76 holds.

Then, it is judged whether the temporarily remaining number of pages R(i) is not less than 0 (step S305). When the temporarily remaining number of pages R(i) is judged as being not less than 0 in step S305, it is judged that the number of pages of {(signature maximum page number M)/2^{t}} can be assigned, and the process proceeds into step S306.

In step S306, one record frame is generated.

Then, the imposed page number calculating part 123 outputs the temporarily subtracted value of {(signature maximum page number M)/2^{t}} in the previous step S304, as the number of imposed pages S(i) for the generated record frame i (step S307). Since R(1)=76, the record frame 1 is generated, and S(1)=16 holds.

Next, the number of pages Q(i) is set at the value of the temporarily remaining number of pages R(i) (step S308). That is, following the generation of the record frame i, the number of pages (number of pages Q(i)) remaining before generating the next record frame (i+1) is set at the temporarily remaining number of pages R(i). Since R(1)=76, the page number Q(1)=76 holds.

Next, it is judged whether or not the number of pages Q(i) is 0 (step S309).

When the number of pages Q(i) is judged as not being 0 in step S309, it is judged that there remains pages to be assigned, and the value i is set at (i+1) (step S310), and the process returns to step S304. Since Q(1)=76, it is judged that Q(1) is not 0, and the process proceeds into step S310. Steps S310 and S304 to S309 are repeated four times, so that the record frames 2 to 5 are generated. When the record frame 5 is generated in step S306, then steps S307 to S310 are carried out, and the process proceeds into step S304, where R(6)=−4 is obtained. Accordingly, it is judged in the following step S305 that the temporarily remaining number of pages R(i) is less than 0.

When the temporarily remaining number of pages R(i) is judged as being less than 0 in step S305, it is judged that the number of pages of {(signature maximum page number M)/2^{t}} cannot be assigned, and the process proceeds into step S311. In step S311, the value t is incremented by 1, and the temporarily remaining number of pages R(i) is calculated again (step S304), following which the judgment in step S305 is made. That is, it is judged whether or not the number of pages of {(signature maximum page number M)/2^{t}} can be assigned while decreasing the value of {(signature maximum page number M)/2^{t}} to be temporarily subtracted from the page number Q(i−1). The value t is set at its maximum value within a range that the value of {(signature maximum page number M)/2^{t}} does not exceed Q(i−1) so that the maximum number of pages shall be imposed on a single intermediate signature. Since Q(5)=12, the value t is incremented by 1 to stand at 1, then, R(6)=4 holds. In such case, the temporary remaining page number R(6) is judged as being not less than 0 in step S305, and the process proceeds into step S306, where a record frame 6 is generated. The imposed page number S(6) for the record frame 6 stands at 8. Thereafter, steps S308 to S310 and steps S304 to S306 are carried out, so that a record frame 7 is generated. When the record frame 7 is generated in step S306, step S308 is carried out, and then the process proceeds into step S309, where the page number Q(7) is judged as being 0.

When the number of pages Q(i) is judged as being 0 in step S309, it is judged that there is no page to be assigned, and the process proceeds into step S312.

In step S312, the intermediate signature numbering part 124 gives intermediate signature numbers A(i) from 1 in ascending order of generation of record frames i, and outputs them.

Subsequently, the composite signature numbering part 125 gives composite signature numbers B(i) from 1 in ascending order of generation of record frames i, and outputs them (step S313).

Next, the page numbering part 126 obtains the start page number PS(i) and end page number PE(i) (step S314). First, the initial value of the start page number PS(1) is set at 1. Then, the start page number PS(i) is calculated in the order of generation of record frames i by performing the operation shown in Equation 1. The end page number PE(1) is set at the imposition number S(1). Then, the end page number PE(i) is calculated in the order of generation of record frames i by performing the operation shown in Equation 2.

PS(i)=PS(i−1)+S(i−1) Equation 1

PE(i)=PE(i−1)+S(i) Equation 2

For instance, PS(2)=18 and PE(2)=32 hold.

With the above-described process, the first table T1 is generated from the initial information obtained by the initial information obtaining section 110. The generated first table T1 is stored in the RAM 13.

### Second Table

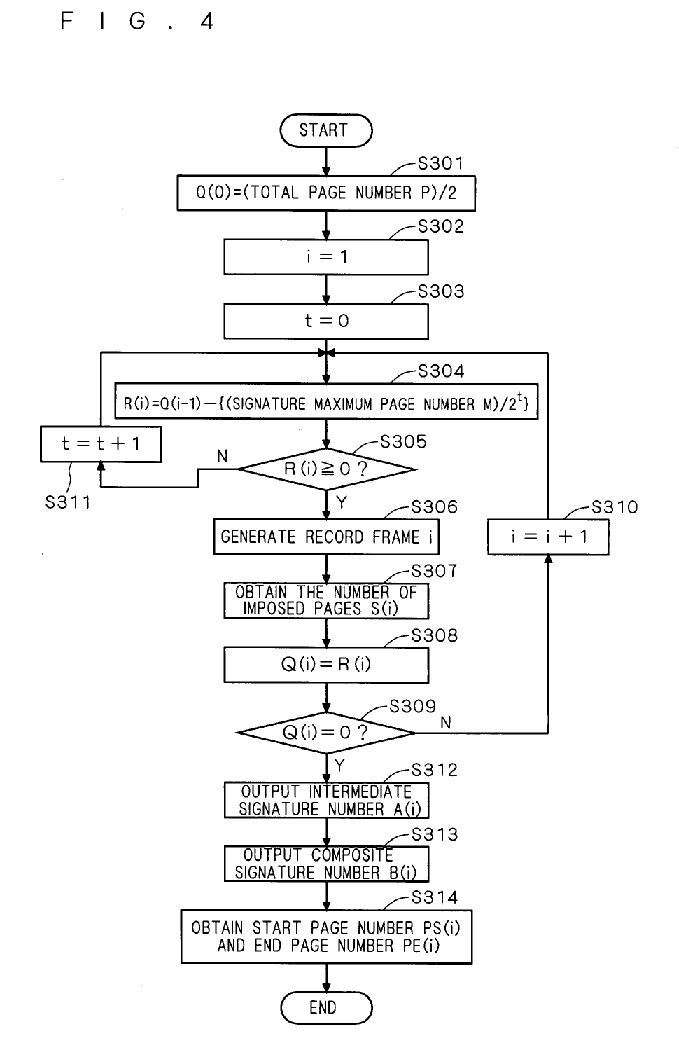

The flow chart shown in FIG. 3 is referred to again. Upon completion of step S23, the second table generating section 130 generates the second table T2 on the basis of the first table T1 generated in step S23 (step S24). FIG. 5 is a flow chart showing the steps of generating the second table T2.

First, the record frame generating part 131 generates record frames i (i=1, 2, . . . ) constituting the second table T2 (step S401), and more specifically, sequentially generates record frames as many as the record frames i (i=1, 2, . . . ) generated in the first table T1. Herein, the imposed page number calculating part 132 obtains the number of imposed pages S(i) stored in the record i in the first table T1 to output it as the number of imposed pages S(i) for the record frame i in the second table T2. Since the first table T1 contains the record frames 1 to 7, the record frames i (i=1, 2, . . . 7) are sequentially generated in the second table T2.

Subsequently, the intermediate signature numbering part 133 gives values in ascending order in correspondence to the reverse order of generation of record frames i from an initial value larger by 1 than the maximum value of intermediate signature numbers given in the first table T1, to thereby output the intermediate signature number A(i) (step S402). Since the maximum value of the intermediate signature numbers in the first table T1 is 7, the intermediate signature number A(7)=8 holds.

Then, the composite signature numbering part 134 gives numbers from 1 in ascending order of generation of record frames i, to thereby output the composite signature number B(i) (step S403).

Next, the page numbering part 135 obtains the start page number PS(i) and end page number PE(i) (step S404). First, the start page number PS(M2) is set at the value of the end page number PE(M1)+1. Then, an operation indicated by Equation 3 is made in descending order of generation of record frames i, to thereby calculate the start page number PS(i). The end page number PE(M2) is set at the value of {the end page number PE(M1)+imposed page number S(M2)}, and an operation indicated by Equation 4 is made in descending order of generation of record frames i, to thereby calculate the end page number PE(i).

PS(i)=PS(i+1)+S(i+1) Equation 3

PE(i)=PE(i+1)+S(i) Equation 4

For instance, PS(7)=93 (i.e., 1 added to the end page number PE(7)=92 of the record frame 7 in the first table T1) and PE(7)=96 hold.

The second table T2 is generated with the above-described processing. In summary, the second table T2 is generated from the first table T1 generated on the basis of the initial information obtained by the initial information obtaining section 110. The generated second table T2 is stored in the RAM 13.

### 3-3. Third table Generating Process

The flow chart shown in FIG. 3 is referred to again. Upon completion of step S24, the third table generating section 140 generates the third table T3 on the basis of the first table T1 generated in step S23 and second table T2 generated in step S24 (step S25). FIG. 6 is a flow chart showing the steps of generating the third table T3.

First, the record frame generating part 141 generates record frames i (i=1, 2, . . . ) constituting the third table T3 (step S501), and more specifically, sequentially generates record frames i as many as the record frames i (i=1, 2, . . . ) generated in the first table T1 (or second table T2).

Subsequently, the composite signature numbering part 142 outputs the composite signature number B(i) (step S502), and more specifically, obtains the value of the composite signature number B(i) stored in the record frame i in the first table T1 (or second table T2), to thereby output it as the composite signature number B(i) for the record frame i in the third table T3.

Then, the intermediate signature numbering part 143 outputs the intermediate signature number A(i) (step S503), and more specifically, obtains the value of the intermediate signature number A(i) for the record i in the first table T1 and the value of the intermediate signature number A(i) for the record i in the second table T2, to output these two values as the intermediate signature number A(i) for the record frame i in the third table T3. Further, the intermediate signature numbering part 143 obtains the respective values of the number of imposed pages S(i), start page number PS(i) and end page number PE(i) for the record i stored in the first table T1, to output them for the same items of the record frame i in the third table T3, and also obtains the respective values of the number of imposed pages S(i), start page number PS(i) and end page number PE(i) for the record i stored in the second table T2, to output them for the same items of the record frame i in the third table T3. For instance, the intermediate signature number A(1)=1, 14 holds.

The pagination number calculating part 144 calculates the number of pagination L(i) (step S504), and more specifically, calculates the sum of two imposed page numbers S(i) stored in the record frame i, to output it as the imposed page number L(i). Since the values 16 and 16 are stored in S(1), L(1)=32 holds.

The signature group numbering part 145 gives the signature group number G(i), and more specifically, forms signature groups each composed of records i having the same number of pagination L(i), and gives numbers from 1 that identify the respective signature groups from one another in ascending order of generation of the signature groups. Since the record frames 1, 2, 3, 4 and 5 all have a number of pagination L(i) of 32, a signature group 1 containing these records is formed. In other words, the signature group numbers G(1), G(2), G(3), G(4) and G(5) are all stand at 1.

The third table T3 is generated with the above-described processing. In summary, the third table T3 is generated from the first table T1 generated on the basis of the initial information obtained by the initial information obtaining section 110 and the second table T2. The generated third table T3 is stored in the RAM 13.

### 3-4. Fourth Table Generating Process

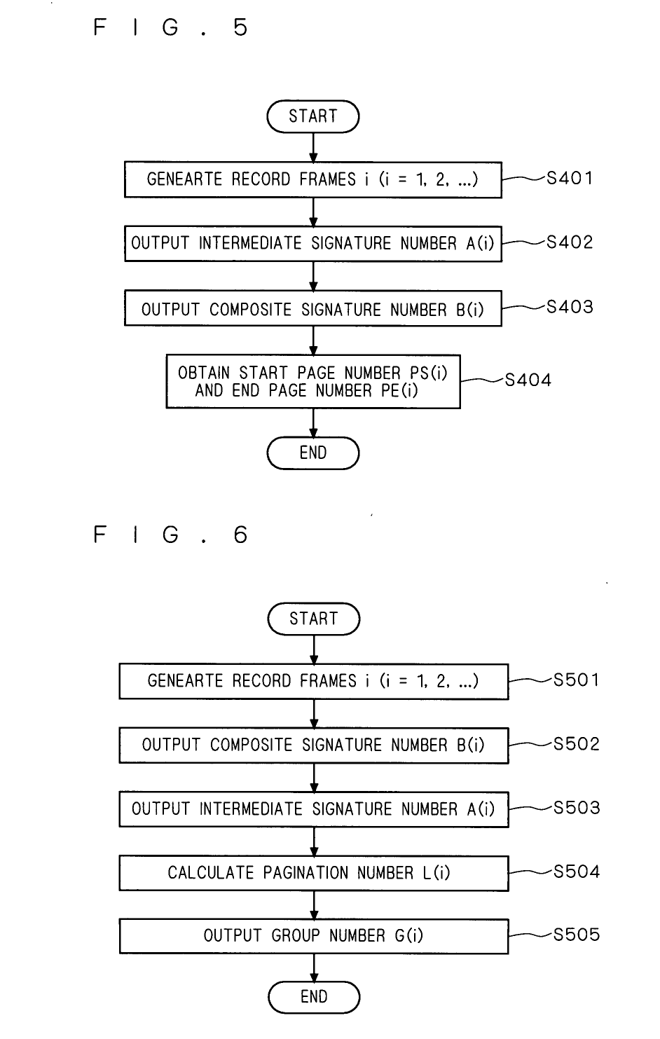

The flow chart shown in FIG. 3 is referred to again. Upon completion of step S25, the fourth table generating section 150 generates the fourth table T4 on the basis of the third table T3 generated in step S25 (step S26). FIG. 7 is a flow chart showing the steps of generating the fourth table T4.

First, the value g is set at 1 (step S601). Herein, assignment of composite signatures to printing forms shall be performed per signature group, and the value g represents the group number of a signature group being subjected to processing.

Next, referring to the third table T3, records i whose signature group number G(i) is g are all read out (step S602). At the same time, the number of pagination L(i) of the records i whose signature group number G(i) is g (hereinafter referred to as “group pagination number LG(g)” (g=1, 2, . . . )) is read out. Herein, the records 1, 2, 3, 4 and 5 whose signature group number G(i) is 1 are read out from the third table T3 (cf. FIG. 12), and LG(1)=32 holds.

Then, the record frame generating part 151 generates record frames for the records constituting the fourth table T4 one by one, and the composite signature numbering part 152 outputs the composite signature number B(i) for the generated record i. This processing will now be described more specifically.

First, the maximum number of composite signatures that can be laid out on a printing form (maximum layout number N) is obtained by dividing the sheet maximum page number m by the group pagination number LG(g) (step S603). Since LG(1)=32, N=2 holds.

Next, the value i is set at 1 (step S604).

Then, the value r is set at 0 (step S605). The number r will define the number of composite signatures to be assigned to each printing form as will be described later.

Next, a temporary remaining composite signature number U(i) is obtained by performing an operation of: W(i−1)−{(maximum layout number N)/2^{r}} (step S606). In this expression, the term W(i−1) indicates the number of composite signatures remaining after assigning composite signatures to a printing form corresponding to the (i−1)th record. The composite signature number W(0) which is an initial value of the composite signature number W(i) (i.e., the number of composite signatures before assignment of composite signatures to printing forms is performed) is set at the total number of records read out in step S602. The term {(maximum layout number N)/2^{r}} is a value set as a candidate for the number of composite signatures to be assigned to a printing form corresponding to the i-th record. That is, the temporary remaining composite signature number U(i) is the number of composite signatures remaining after temporarily subtracting composite signatures of {(maximum layout number N)/2^{r}} from composite signatures not assigned to printing forms. Since W(0)=5 and N=2, U(1)=3 holds.

Then, it is judged whether the temporary remaining composite signature number U(i) is not less than 0 (step S607). When the temporary remaining composite signature number U(i) is judged as being not less than 0 in step S607, it is judged that composite signatures of {(maximum layout number N)/2^{r}} can be assigned, and the process proceeds into step S608.

In step S608, one record frame is generated. The value r is output as the number of layout E(i) for the generated record frame i.

Then, the composite signature numbering part 152 outputs the composite signature number B(i) for the generated record frame i (step S609). Composite signatures of {(maximum layout number N)/2^{r}} can be assigned to a printing form corresponding to the record i. Thus, this value shall be the number of composite signatures to be stored in the composite signature number B(i) for the record frame i. Then, the composite signature numbering part 152 first reads out, in ascending order, the {(maximum layout number N)/2^{r}} of records i in the third table T3 as read out in step S603. Further, the composite signature number B(i) of each record i of the {(maximum layout number N)/2^{r}} having been read out is output as the composite signature number B(i) for the record frame i. The intermediate signature numbering part 153 outputs the intermediate signature number A(i) of each record i of the {(maximum layout number N)/2^{r}} having been read out as the intermediate signature number A(i) for the record i. For instance, two composite signatures are assigned to a printing form corresponding to the record 1. The records 1 and 2 are thus read out, and B(1)=1, 2 holds. Also, A(1)=1, 14, 2, 13 holds.

Next, the temporary remaining composite signature number U(i) is set at the composite signature number W(i) (step S610). More specifically, following the generation of the record frame i, the temporary remaining composite signature number U(i) is set at the composite signature number W(i) at a stage of generating the next record frame (i+1). Since U(1)=3, W(1)=3 holds.

Next, it is judged whether or not the composite signature number W(i) is 0 (step S611).

When the composite signature number W(i) is judged as not being 0 in step S611, it is judged that there remains composite signatures to be assigned, and the value i is set at (i+1) (step S612), and the process returns to step S606. Since W(1)=3, it is judged that W(1) is not 0, and the process proceeds into step S611. Thereafter, steps S612 and S606 to S608 are carried out once, so that the record frame 2 is generated. When the record frame 2 is generated in step S608, steps S610 to S612 are carried out, and the process proceeds into step S606, where U(2)=−1 is obtained. Then, it is judged in the following step S607 that the temporary remaining page number U(2) is less than 0.

When the temporary remaining composite signature number U(i) is judged as being less than 0 in step S607, it is judged that composite signatures of {(maximum layout number N)/2^{r}} cannot be assigned, and the process proceeds into step S613. In step S613, the value r is incremented by 1, and the temporary remaining composite signature number U(i) is calculated again (step S606), following which the judgment in step S607 is made. That is, it is judged whether or not it is possible to assign composite signatures of {(maximum layout number N)/2^{r}} while decreasing the value of {(maximum layout number N)/2^{r}} to be temporarily subtracted from the composite signature number W(i−1). That is, the value r is set at its maximum value within a range that the value of {(maximum layout number N)/2^{r}} does not exceed W(i−1) so that the maximum number of composite signatures shall be assigned to a single printing form. Since W(2)=1, the value r is incremented by 1 to stand at 1, then, U(3)=0 holds. In this case, the value of U(3) is judged as being not less than 0 in step S608, and the process proceeds into step S609, where the record frame 3 is generated. The process proceeds into step S610 and then step S611, where the value of U(3) is judged as being 0.

When the temporary remaining composite signature number U(i) to be assigned is judged as being 0 in step S611, it is judged that there is no composite signature to be assigned, and the process proceeds into step S614.

In step S614, it is judged whether or not the value g is the maximum value of the signature group number G(i) by referring to the third table T3.

When it is judged in step S614 that the value g is not the maximum value of the signature group number G(i), it is judged that there remains composite signatures to be assigned, and the value g is set at (g+1) (step S615), and the process returns to step S602.

When it is judged in step S614 that the value g is the maximum value of the signature group number G(i), it is judged that there is no composite signature to be assigned, and the process proceeds into step S616.

In step S616, the printing form numbering part 154 gives numbers from 1 in ascending order of generation of record frames i, and outputs the printing form number Y(i).

The fourth table T4 is generated with the above-described processing. In summary, the fourth table T4 is generated from the third table T3 generated from the first and second tables T1 and T2. The generated fourth table T4 is stored in the RAM 13.

### 3-5. Signature Layout Table Generation

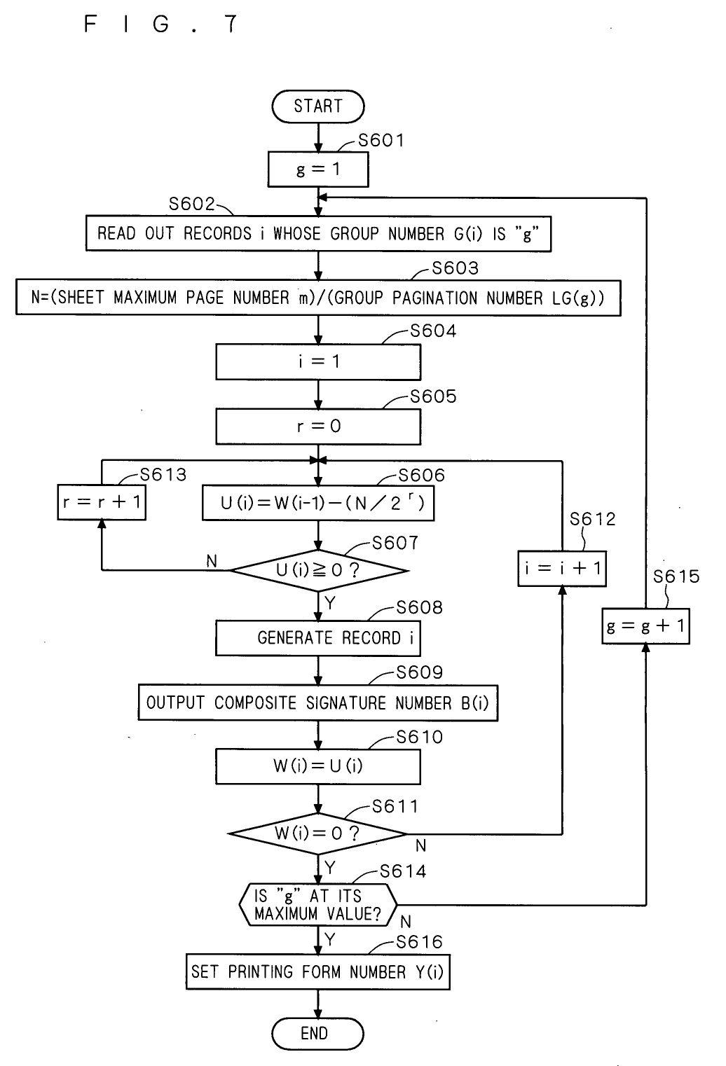

The flow chart shown in FIG. 3 is referred to again. Upon completion of step S26, the signature layout table generating section 160 generates the signature layout table T5 on the basis of the third table T3 generated in step S25 (step S27). FIG. 8A is a flow chart showing the steps of generating the signature layout table T5.

First, the record frame generating part 161 generates record frames i (i=1, 2, . . . ) constituting the signature layout table T5 (step S701), and more specifically, sequentially generates record frames i as many as the record frames i (i=1, 2, . . . ) generated in the third table T3.

Next, the record frame generating part 161 further outputs the respective values of: composite signature number B(i); intermediate signature number A(i); number of imposed pages S(i); start page number PS(i); and end page number PE(i) (step S702), and more specifically, obtains the respective values of: composite signature number B(i); intermediate signature number A(i); number of imposed pages S(i); start page number PS(i); and end page number PE(i) stored in the record i in the third table T3 to output them as values of the same items of the record i in the signature layout table T5. It should be noted that the obtained start page number PS(i) is output as the start value of the page number P(i), and the obtained end page number PE(i) is output as the end value of the page number P(i).

Then, the imposition pattern selecting part 162 selects an imposition pattern SQ for the generated record frame i (step S703). More specifically, candidates for imposition pattern (e.g., an imposition pattern that can be selected for the selected plate type H and imposed page number L(i)) are first read out from among a plurality of candidates for imposition pattern (e.g., imposition patterns a1, a2, . . . ) having been read by the media drive 14 (or previously stored in the RAM 13 or the like). Then, processing for prompting a user to select either one of the candidates for imposition pattern having been read out (e.g., by displaying the list of selectable imposition patterns and a message reading “Select an imposition pattern” on the display unit 16) follows. When the user selects and enters one of the imposition patterns in response to the message, then, the entered imposition pattern is selected as the imposition pattern SQ for the record frame i. For instance, when a pattern a is selected as the imposition pattern SQ for the record 1, the sign “a” that identifies the pattern is input in the item of imposition pattern SQ.

The signature layout table T5 is generated with the above-described processing, and stored in the RAM 13. The generated signature layout table T5 can be displayed on the display unit 16 in response to a user's instruction.

### 3-6. Printing Form Layout Table Generating Process

The flow chart shown in FIG. 3 is referred to again. Upon completion of step S27, the printing form layout table generating section 170 generates the printing form layout table T6 on the basis of the fourth table T4 generated in step S26 (step S28). FIG. 8B is a flow chart showing the steps of generating the printing form layout table T6.

First, the record frame generating part 171 generates record frames i (i=1, 2, . . . ) constituting the printing form layout table T6 (step S801), and more specifically, sequentially generates record frames i as many as the record frames i (i=1, 2, . . . ) generated in the fourth table T4.

Next, the record frame generating part 171 outputs the respective values of printing form number Y(i), composite signature number B(i), intermediate signature number A(i) and number of layout E(i), and more specifically, obtains the respective values of printing form number Y(i), composite signature number B(i), intermediate signature number A(i) and number of layout E(i) stored in the record i in the fourth table T4, to output them as values of the same items of the record i in the printing form layout table T6.

Then, the form copy number calculating part 172 calculates the form copy number V(i) for the generated record i (i=1, 2, . . . ) (step S803). More specifically, processing is carried out for prompting a user to enter the total volumes J (the total number of printed matter to be produced) (e.g., by displaying a message reading “Enter the total volumes” on the display unit 16). When a user enters the total volumes J in response to the message, then, the total volumes J is divided by the number of layout E(i), so that the form copy number V(i) is obtained. For instance, when the total volumes J of 10,000 is entered, the form copy number V(i) of the record 1 whose imposition number E(1) is 1 stands at 10,000.

The printing form layout table T6 is generated with the above-described processing, and stored in the RAM 13. The generated printing form layout table T6 can be displayed on the display unit 16 in response to a user's instruction.

The flow chart shown in FIG. 3 is referred to again. Upon completion of step S28, layout planning is completed.

### 4. Advantageous Effects

With the layout planning apparatus 1 according to the above-described embodiment, layout planning for the multiple-signature-single-volume style can be carried out by only having the initial information obtaining section 110 obtain the total page number P, signature maximum page number M and sheet maximum page number m, as initial information. More specifically, the first and second tables T1 and T2 are generated from the initial information obtained by the initial information obtaining section 110, and the third table T3 is generated from these first and second tables T1 and T2. The fourth table T4 is further generated from the third table T3. That is, a user can carry out layout planning for the double-signature-single-signature style only by entering the total page number P and plate type H.

With the layout planning apparatus 1, the second table generating section 130 generates the second table T2 on the basis of the first table T1 generated by the first table generating section 120. More specifically, the record frame generating part 131 and imposed page number calculating part 132 of the second table generating section 130 obtain the record i and the number of imposed pages S(i) in the previously generated first table T1 by copying, and output them as the record i and the number of imposed pages S(i) in the second table T2. That is, the second table generating section 130 does not practically perform record generation or imposed page number calculation, which increases the efficiency in table generation as compared to the case of generating the first and second tables T1 and T2 independently. In short, layout planning can efficiently be carried out.

Further, with the layout planning apparatus 1, the composite signature numbering part 152 assigns composite signatures to printing forms per group generated with respect to the signature page number L(i). That is, signatures belonging to the same signature group are assigned to one printing form. This can increase the types of pages to be assigned to a single printing form. In other words, the printing form layout table T6 achieving excellent printing efficiency can be generated.

### 5. Other Preferred Embodiments

While the above-described embodiment has described layout planning assuming that page data is made up of a single type of component (e.g., monochrome body), layout planning when page data is made up of a plurality of types of components (e.g., monochrome body and color body) will be achieved as described below.

In such case, components contained in page data are previously grouped based on their types prior to step S21 (cf. FIG. 3) (e.g., dividing monochrome pages and color pages into different groups).

Step S21 then follows, where the total number of page data belonging to a first group (herein, e.g., the group of monochrome pages) is read as the total page number P of page data. Then, steps S22 to S26 are carried out for the first group. That is, the first to fourth tables T1 to T4 are generated for the first group.

Upon completion of step S26, the process returns to step S21 prior to proceeding into step S27, where the total number of page data belonging to a second group (herein, e.g., the group of color pages) is read as the total page number P of page data. Then, steps S22 to S26 are carried out for the second group. That is, the first to fourth tables T1 to T4 are generated for the second group.

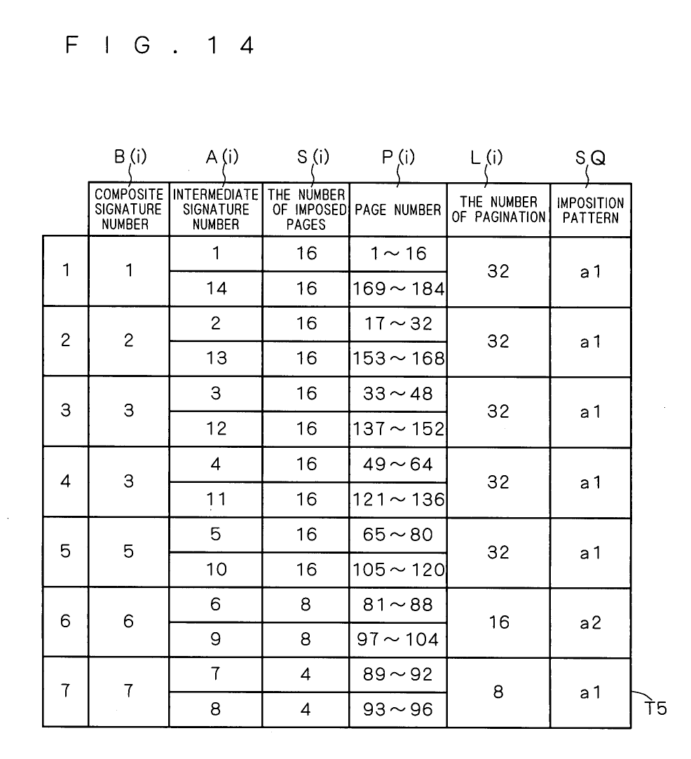

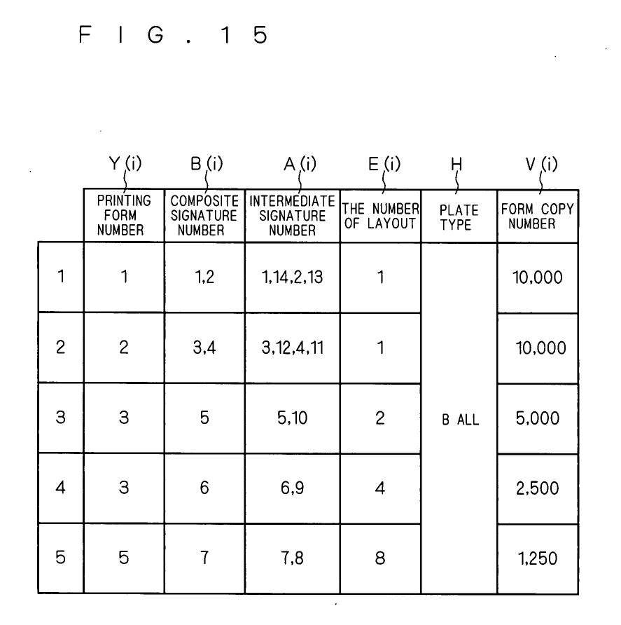

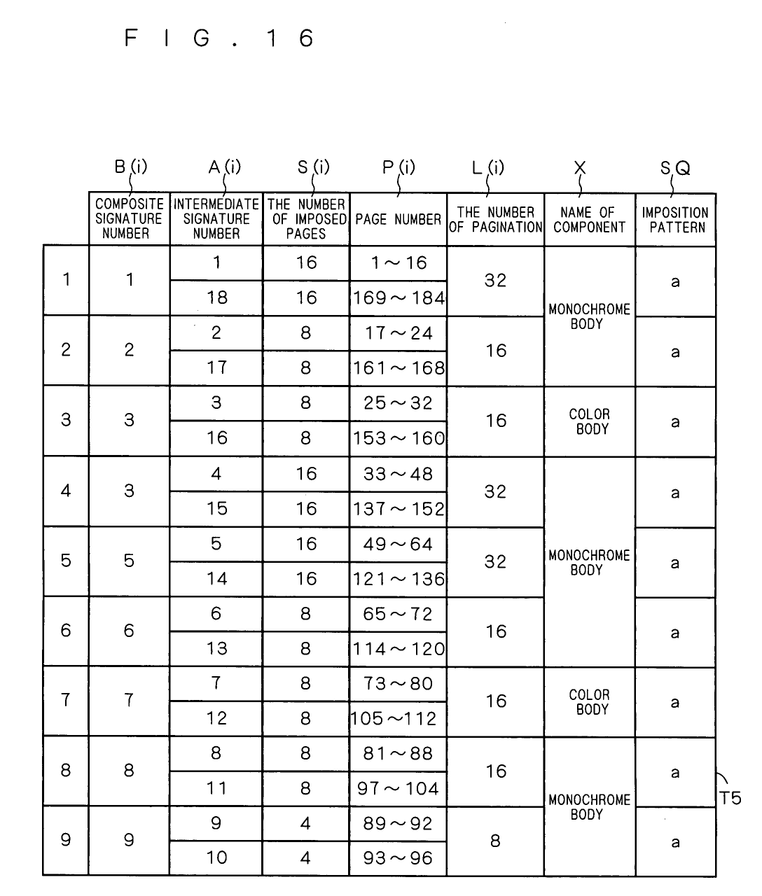

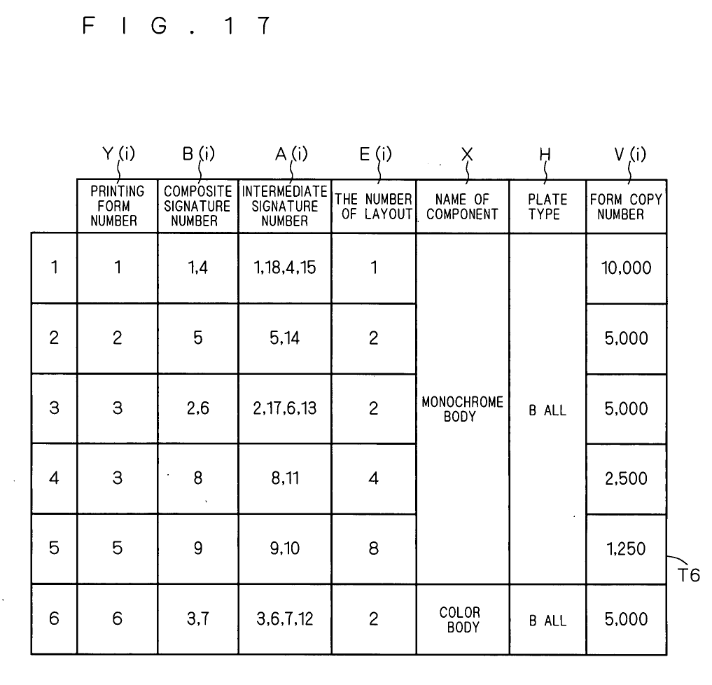

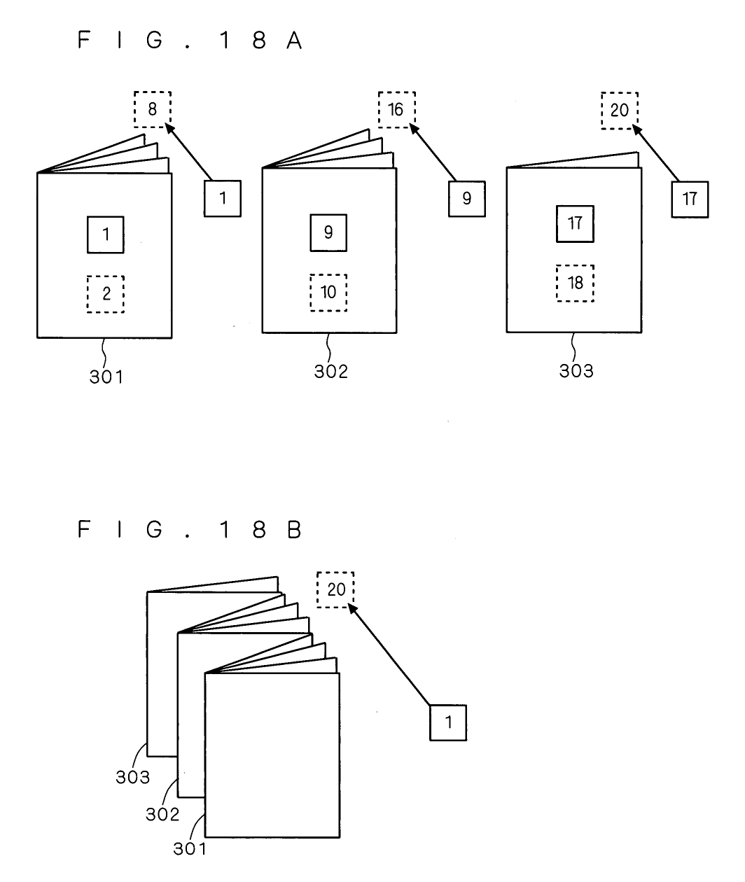

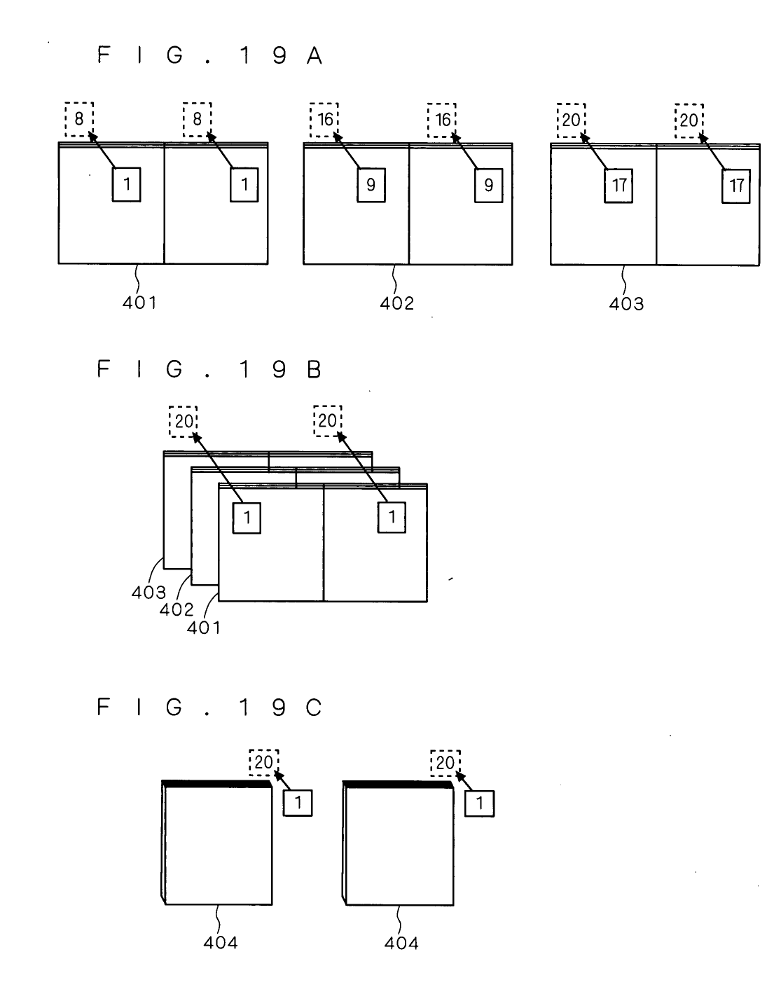

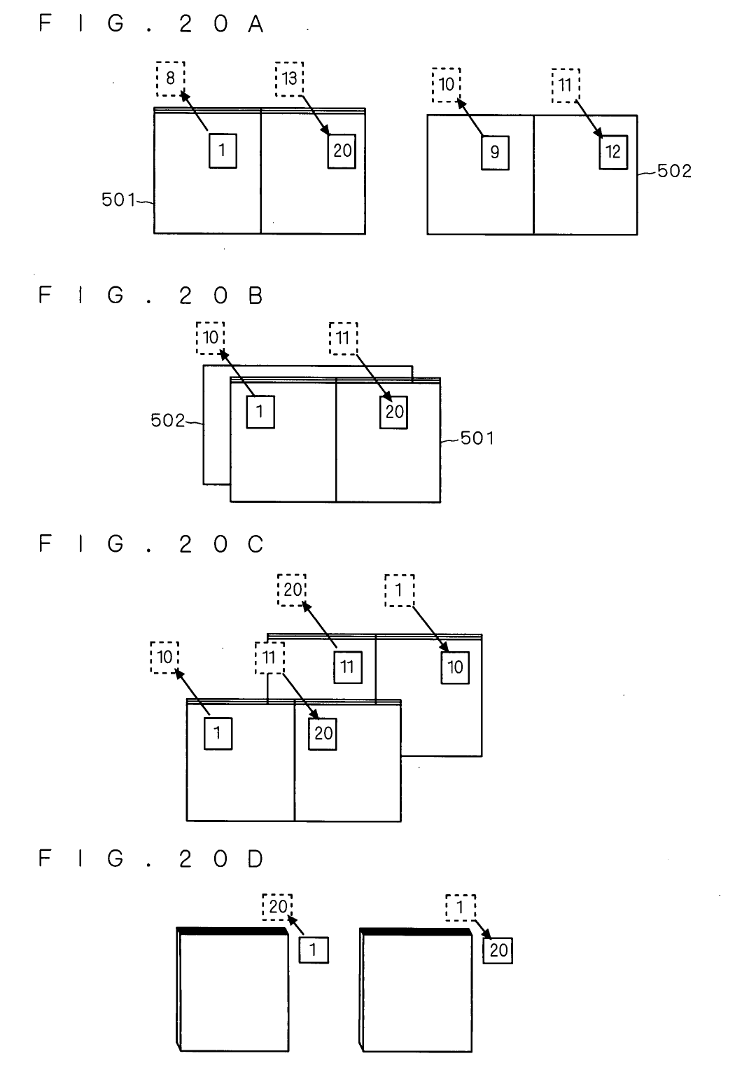

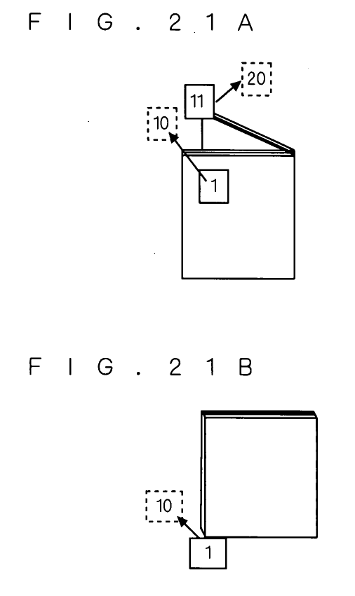

When the first to fourth tables T1 to T4 are generated for all the groups, the process proceeds into steps S27 and S28, where the signature layout table T5 and printing form layout table T6 are generated on the basis of the third and fourth tables T3 and T4 generated for each group. The first to third tables T1 to T3 may be generated for each group, and a single fourth table T4 may be generated from a plurality of third tables T3 as generated. FIGS. 16 and 17 are diagrams respectively showing an exemplary construction of the signature layout table T5 and printing form layout table T6 generated by processing described herein.

That is, by carrying out steps S21 to S26 described in the above-described embodiment a plurality of times, layout planning can be carried out for the multiple-signature-single-volume style according to any pattern even when color and monochrome pages are mixed, for example.

While in the above-described embodiment, the intermediate signature numbering part 124 gives intermediate signature numbers in ascending order of generation of record frames in generation of the first table T1 (step S309; cf. FIG. 4), the numbers may be given in ascending order of the reverse order of generation of record frames. In such case, in generation of the second table T2, the intermediate signature numbering part 133 gives intermediate signature numbers in ascending order from a value larger by 1 than the maximum value of intermediate signature numbers given in the first table T1 in the order of generation of record frames.

Further, the above-described embodiment has been directed to layout planning for the double-signature-single-volume style with two different intermediate signatures paginated on each composite signature, however, layout planning for a binding style with n different intermediate signatures paginated on each composite signature can be carried out, where n is a power of 2, i.e., n=2^{m} (m is a natural number). More specifically, in the above-described embodiment, two tables (i.e., first and second tables T1 and T2) showing the page composition of each intermediate signature in each position since two intermediate signatures are paginated on each composite signature. When n intermediate signatures are paginated on each composite signature, n tables showing the page composition of each intermediate signature in each position may be generated. In this case, the second and subsequent tables can be generated with similar processing as the second table generated in the above-described embodiment. That is, the second and subsequent tables can be generated by obtaining necessary information (e.g., the total number of record frames to be generated, imposed page number of each record) from a table generated first (the first table T1 in the above-described embodiment).

Furthermore, values of the signature maximum page number and sheet maximum page number are obtained using a single type of layout planning master in the above-described embodiment, however, a plurality of types of layout planning masters may be used. For instance, when a printing/binding system line is provided with a plurality of folding machines and printing press, layout planning masters for every combination of folding machine and printing press may be stored in the RAM 13 (cf. FIG. 1) or the like, and the initial information obtaining section 110 (cf. FIG. 2) may prompt a user to select a combination of folding machine and printing press to determine which layout planning master is to be referred to. Alternatively, a user may directly enter values of the signature maximum page number and sheet maximum page number, rather than determining these numbers using a layout planning master.

Still further, the signature layout table and printing form layout table may contain user's desired various types of information in addition to the items having been described in the above-described embodiment. For instance, the printing form layout table may further contain the items of “name of component”, “number of printing plates”, “color”, “printing office”, “paper brand (supplier)”, “paper size (print size)”, “specifications”, “ream number (ream weight)”, “practical number of copies”, “number of spare copies”, “actual purchase number of copies”, etc. for each printing form. It is noted that FIGS. 16 and 17 respectively show an exemplary construction of the signature layout table T5 and printing form layout table T6 with the item of “name of component” added.

While the invention has been shown and described in detail, the foregoing description is in all aspects illustrative and not restrictive. It is therefore understood that numerous modifications and variations can be devised without departing from the scope of the invention.

What is claimed is:

1. A layout planning apparatus for carrying out layout planning for a printing/binding style of creating a plurality of signatures for use in production of printed matter, different contents being imposed on n imposition areas (where n is a power of 2) on each of said plurality of signatures, said layout planning apparatus comprising:
an initial information obtaining section obtaining, as initial information, the total number of pages of said printed matter, a signature maximum page number representing a maximum number of pages that can be laid out on each of said n imposition areas and a sheet maximum page number representing a maximum number of pages that can be laid out on a sheet of printing paper;
an area table generating section generating n area tables, said n area tables each showing a page composition of a predetermined imposition area included in said n imposition areas throughout said plurality of signatures, said predetermined imposition area arranged in a common position throughout said plurality of signatures, said area table generating section specifying said page composition on the basis of said initial information;
a signature layout table generating section generating a signature layout table showing a page composition of each of said plurality of signatures on the basis of said n area tables; and
a printing form layout table generating section generating a printing form layout table showing a page composition of each printing form on the basis of said signature layout table.

2. The layout planning apparatus according to claim 1, wherein
said area table generating section includes:
a main area table generating part generating a main area table showing a page composition of a predetermined imposition area included in said n imposition areas; and
a sub-area table generating part generating (n−1) sub-area tables using the contents of said main area table, said (n−1) sub-area tables respectively showing page compositions of (n−1) imposition areas included in said n imposition areas except said predetermined imposition area.

3. The layout planning apparatus according to claim 2, wherein
said signature layout table generating section generates said signature layout table by extracting the contents of page compositions of imposition areas to be included in a single signature from said n area tables.

4. The layout planning apparatus according to claim 3, wherein
said printing form layout table generating section includes a signature group forming part forming a signature group of signatures each having the same number of pages imposed, and
said printing form layout table generating section generates said printing form layout table by assigning only signatures that belong to the same signature group to a single printing form.

5. The layout planning apparatus according to claim 4, further comprising
an imposition pattern selecting part selecting an imposition pattern in said imposition areas to be included in said single signature.

6. The layout planning apparatus according to claim 5, wherein
said initial information obtaining section includes:
a plate-type selection receiving part referring to a layout planning master and having a user select one of a plurality of plate types contained in said layout planning master, said layout planning master storing each of said plurality of plate types in association with said signature maximum page number and said sheet maximum page number; and
a plate-type-associated information receiving part obtaining said signature maximum page number and said sheet maximum page number corresponding to said one of said plurality of plate types received by said plate-type selection receiving part, from said layout planning master.

7. A computer-readable recording medium having recorded therein a program for causing a computer to function as a layout planning apparatus for carrying out layout planning for a printing/binding style of creating a plurality of signatures for use in production of printed matter, different contents being imposed on n imposition areas (where n is a power of 2) on each of said plurality of signatures, said program being executed by said computer to cause said layout planning apparatus to perform the following steps of:
(a) obtaining, as initial information, the total number of pages of said printed matter, a signature maximum page number representing a maximum number of pages that can be laid out on each of said n imposition areas and a sheet maximum page number representing a maximum number of pages that can be laid out on a sheet of printing paper;
(b) generating n area tables, said n area tables each showing a page composition of a predetermined imposition area included in said n imposition areas throughout said plurality of signatures, said predetermined imposition area arranged in a common position throughout said plurality of signatures, said area table generating section specifying said page composition on the basis of said initial information;
(c) generating a signature layout table showing a page composition of each of said plurality of signatures on the basis of said n area tables; and
(d) generating a printing form layout table showing a page composition of each printing form on the basis of said signature layout table.

8. A layout planning method of carrying out layout planning for a printing/binding style of creating a plurality of signatures for use in production of printed matter, different contents being imposed on n imposition areas (where n is a power of 2) on each of said plurality of signatures, said layout planning method comprising the steps of:
(a) obtaining, as initial information, the total number of pages of said printed matter, a signature maximum page number representing a maximum number of pages that can be laid out on each of said n imposition areas and a sheet maximum page number representing a maximum number of pages that can be laid out on a sheet of printing paper;
(b) generating n area tables, said n area tables each showing a page composition of a predetermined imposition area included in said n imposition areas throughout said plurality of signatures, said predetermined imposition area arranged in a common position throughout said plurality of signatures, said area table generating section specifying said page composition on the basis of said initial information;
(c) generating a signature layout table showing a page composition of each of said plurality of signatures on the basis of said n area tables; and
(d) generating a printing form layout table showing a page composition of each printing form on the basis of said signature layout table.
